(19) United States
(12) Patent Application Publication
(10) Pub. No.: US 2016/0334167 A1
(43) Pub. Date: Nov. 17, 2016

(54) HEAT SINK AND METHOD FOR MANUFACTURING THE SAME

(71) Applicant: Foxconn Technology Co., Ltd., New Taipei (TW)

(72) Inventors: RUNG-AN CHEN, New Taipei (TW); HUNG-NIEN CHIU, New Taipei (TW)

(21) Appl. No.: 14/809,469

(22) Filed: Jul. 27, 2015

(30) Foreign Application Priority Data
May 15, 2015 (TW) 104115521

(51) Int. Cl. F28D 15/02; B23P 15/26

(52) U.S. Cl. CPC F28D 15/02; B23P 15/26; B23P 2700/09

(57) ABSTRACT

The present disclosure provides a heat sink configured for dissipating heat from an electronic component. The heat sink includes a heat pipe and a metal board. The metal board includes a first face and a second face. An opening is defined in the metal board. The opening penetrates the first face and the second face. The heat pipe is received in the opening, and the opening is an interference fit to the heat pipe. The present disclosure also provides a method for manufacturing the heat sink described above.

### CROSS-REFERENCE TO RELATED APPLICATIONS

This application claims priority to Taiwan patent application no. 104115521 on May 15, 2015, the contents of which are incorporated by reference herein.

### FIELD

The subject matter herein generally relates to heat sinks, and more particularly to a heat sink including a base and a plurality of fins combined together and a method for manufacturing the heat sink.

### BACKGROUND

Heat sinks are used for removing heat from heat-generating electronic components such as central processing units (CPUs) and others. Heat sinks can be constructed to include one or more fins protruding from a base. The base can be configured to be in contact or at least partial contact with an electronic component.

### BRIEF DESCRIPTION OF THE DRAWINGS

Implementations of the present technology will now be described, by way of example only, with reference to the attached figures.

FIG. 1 is an isometric view of a heat sink in accordance with the present disclosure.

FIG. 2 is an exploded, isometric view of the heat sink in FIG. 1.

FIG. 3 is a partly enlarged cross section view of the heat sink along a line III-III in FIG. 1, wherein the heat sink has been welded and flatted.

FIG. 4 is a flow chart of a method for forming the heat sink in accordance with the present disclosure.

FIG. 5 is a partly enlarged cross section view of the heat sink in FIG. 1, wherein the heat sink has not been welded and flatted.

FIG. 6 is an isometric view of a heat sink in accordance with the present disclosure.

FIG. 7 is an exploded, isometric view of the heat sink in FIG. 6.

FIG. 8 is an isometric view of a heat sink in accordance with the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

The present disclosure is described in relation to a heat sink and method for manufacturing the same.

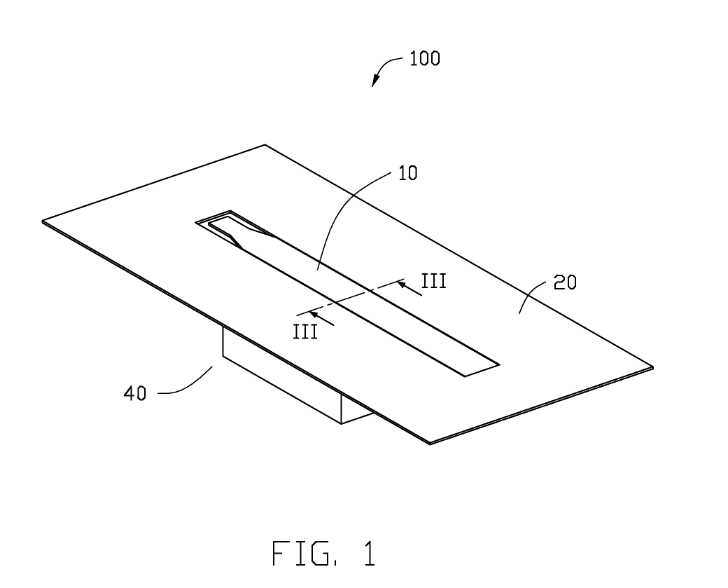

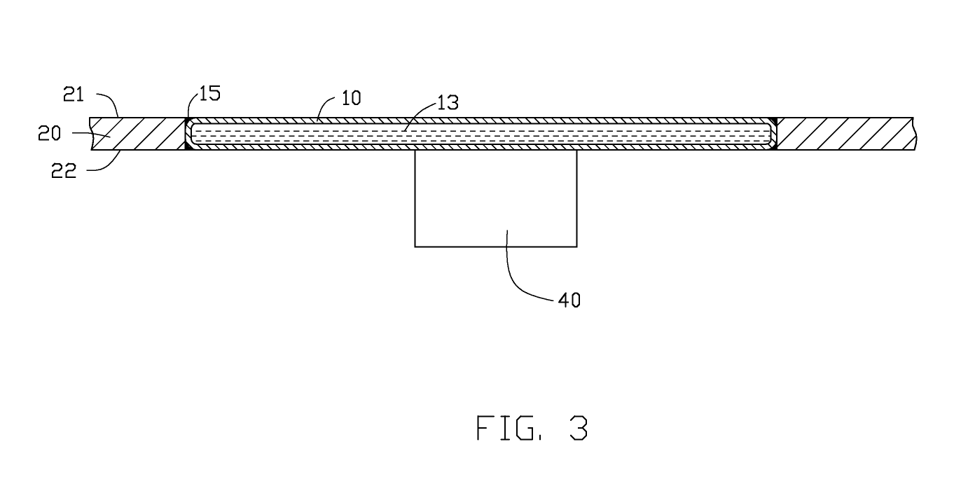

FIGS. 1 and 3 illustrate that a heat sink 100 in accordance with a first embodiment of the present disclosure. The heat sink 100 includes a heat pipe 10 and a metal board 20. The heat sink 100 is used for removing heat from a heat-generating electronic component 40 of electronic equipment. The metal board 20 can be in thermal contact with the electronic component 40. The electronic equipment can be tablet device, smart mobile phone or other thin products. The electronic component can be a central processing unit (CPU) or the like in the electronic equipment.

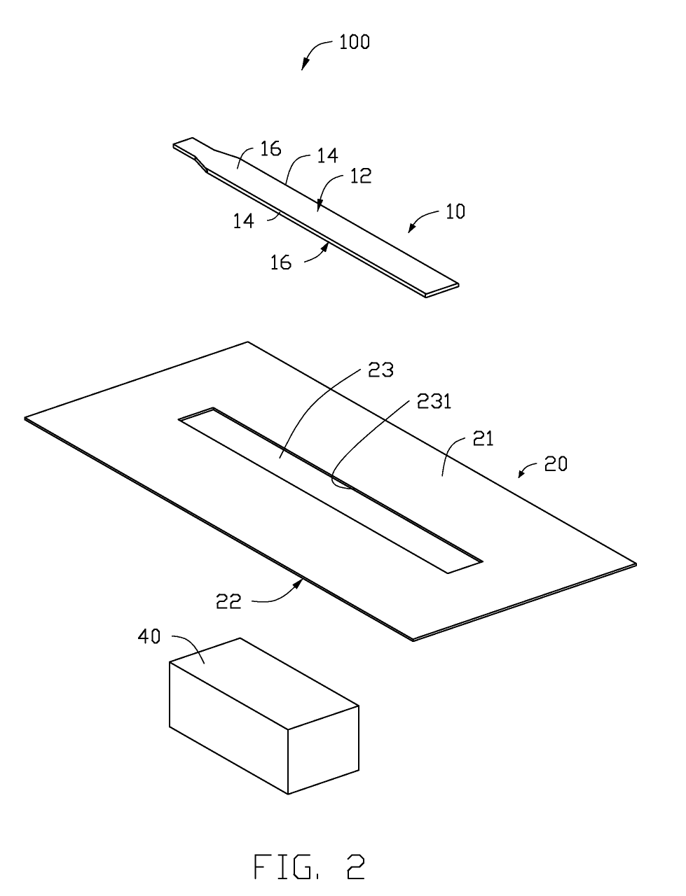

FIG. 2 illustrates that the heat pipe 10 includes casing 12 and working medium 13 (shown in FIG. 3) sealing in the casing 12. Wick structures (not shown) can be formed on inner surfaces of the heat pipe 10 to speed the working medium 13 to flow back, thereby increasing heat dissipating effect of the heat pipe 10 from the electronic component 40. The heat pipe 10 includes two opposite sides 14 on the left and the right thereof and two opposite surfaces 16 on top and bottom thereof. A shape of the heat pipe 10 is not limited to what is illustrated and described. In alternative embodiments responding to the shape can be configured to conform to a desired form factor. In this embodiment, the heat pipe 10 is flat, and a thickness of the heat pipe 10 is less than a width thereof. The two surfaces 16 can be flat planes.

The metal board 20 and the heat pipe 10 are fixed together. The metal board 20 is attached on the electronic component 40 to transfer heat generated by the heat-generating electronic component 40 from the metal board 20 to the heat pipe 10 to enhancing heat dissipation of the heat-generating electronic component 40. The metal board 20 can be made of copper, aluminum and other metal material with good heat conductivity. In this embodiment, the metal board 20 is a planar plate. The metal board 20 includes a first face 21 and a second face 22 opposite to the first face 21. The thickness of the metal board can be equal to a distance between the first face 21 and the second face 22. A thickness of the heat pipe 10 can be substantially equal to that of the metal board 20.

An opening 23 is defined in the metal board 20 and penetrates through the first face 21 and the second face 22. The opening 23 has inner walls 231. The sides 14 of the heat pipe 10 are attached with the inner walls 231 respectively. In this embodiment, a shape and size of the opening 23 are corresponding to those of the heat pipe 10, thereby receiving the heat pipe 10 therein. A width of the opening 23 can be substantially equal to that of the heat pipe 10 and a length of the opening 23 can be larger than that of the heat pipe 10. The inner walls 231 are four planes to form a rectangular shape. The sides 14 of the heat pipe 10 are abutted on the inner walls 231 respectively on opposite sides. The inner walls of the opening 23 are an interference fit to the heat pipe 10. The interference fit, also known as a press fit or friction fit, is a fastening between the opening 23 and the heat pipe 10 which is achieved by friction after the heat pipe 10 and the metal board 20 are pushed together, rather than by any other means of fastening. The side 14 of the heat pipe 10 can be fastened to the corresponding wall 231 of the opening 20, whereby the heat pipe 10 can be soldered to the metal board 20.

In the first embodiment, the two surfaces 16 of the heat pipe 10 are coplanar to the first face 21 and the second face 22 of the metal board 20 respectively. Alternatively, in other embodiments, at least one surface 16 can overtop the first face 21 and the second face 22 respectively.

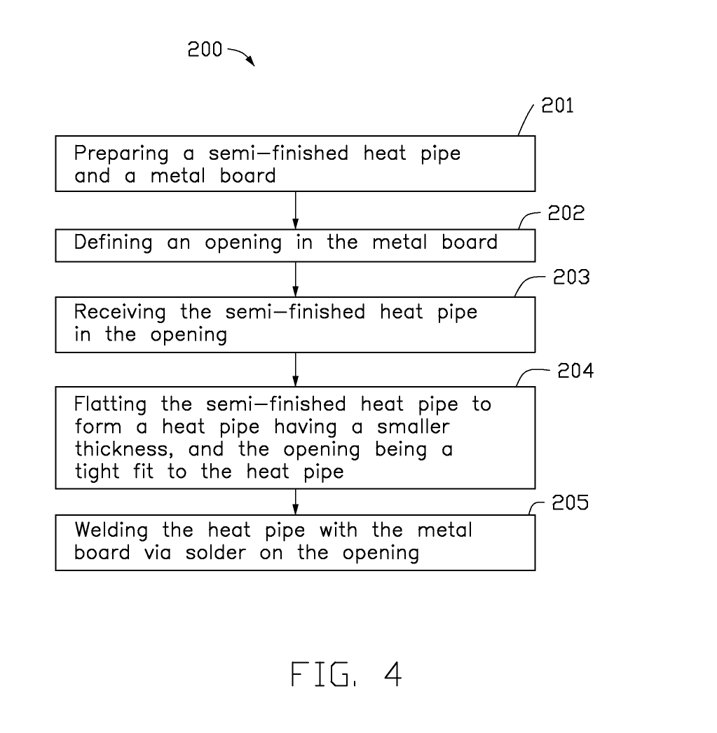

FIG. 4 illustrates a flow chart of a method for forming the heat sink in accordance with the first embodiment of the present disclosure. The example method 200 is provided by way of example, as there are a variety of ways to carry out the method. The method 200 described below can be carried out using the configurations illustrated in FIGS. 1, 2 and 3, for example, and various elements of these figures are referenced in explaining example method 200. Each block shown in FIG. 4 represents one or more processes, methods or subroutines, carried out in the example method 200. Additionally, the illustrated order of blocks is by example only and the order of the blocks can change according to the present disclosure. The example method 200 can begin at block 201.

At block 201, a semi-finished heat pipe 10a and a metal board 20 are prepared.

At block 202, an opening 23 is defined in the metal board 20.

At block 203, the semi-finished heat pipe 10a is received in the opening 23.

At block 204, the semi-finished heat pipe 10a is flatted to form a heat pipe 10 having a smaller thickness, and the opening 23 is an interference fit to the heat pipe 10.

At block 205, the heat pipe 10 is soldered with the metal board 20 at the opening 23.

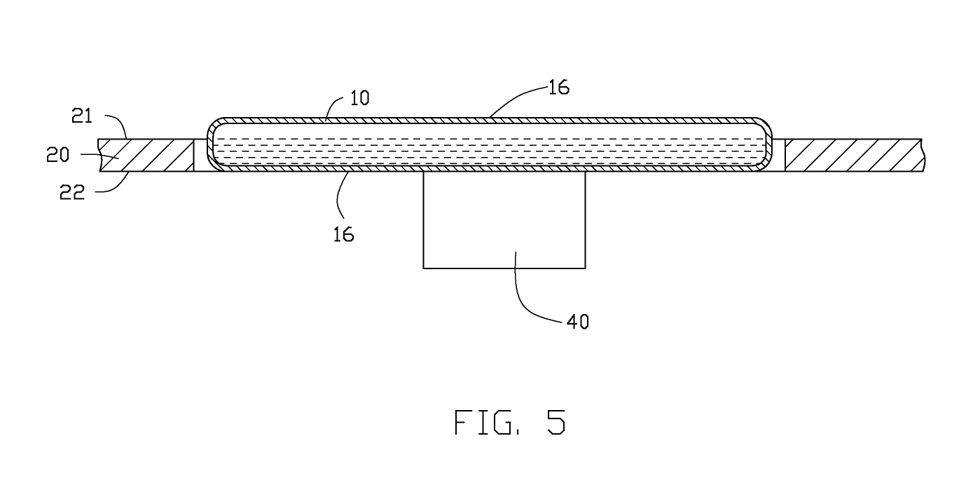

FIG. 5 illustrates the heat sink 100 before flatting the semi-finished heat pipe 10a of FIG. 4. A thickness of the semi-finished heat pipe 10a is larger than that of the metal board 20. One of the surfaces 16 of the semi-finished heat pipe 10a is coplanar to the second face 22 of the metal board 20. And other one of the surfaces 16 overlaps the first face 21 of the metal board 20. When the semi-finished heat pipe 10a is flatted to form the heat pipe 10, a thickness of the heat pipe 10 can be the same as that of the metal board 20. In other embodiments, the thickness of the heat pipe 10 is less than that of the semi-finished heat pipe 10a, but can also be larger than that of the metal board 20. The metal board 20 can be made by aluminum extrusion molding, casting molding, or other fabricating processes. The opening 23 can be made by molding or cutting. The semi-finished heat pipe 10a is flatted by pressing or punching. The heat pipe 10 can be fastened to the opening 20, whereby the heat pipe 10 is be soldered to the metal board 20.

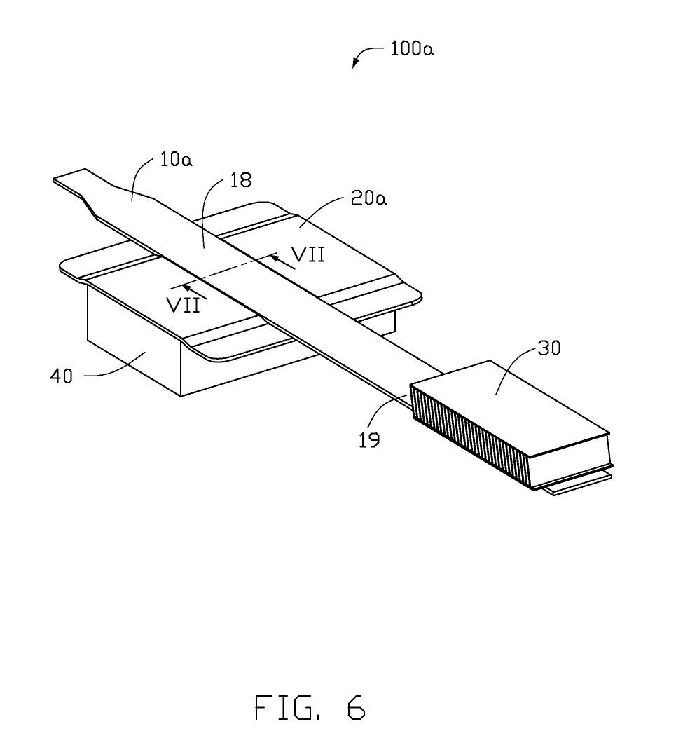

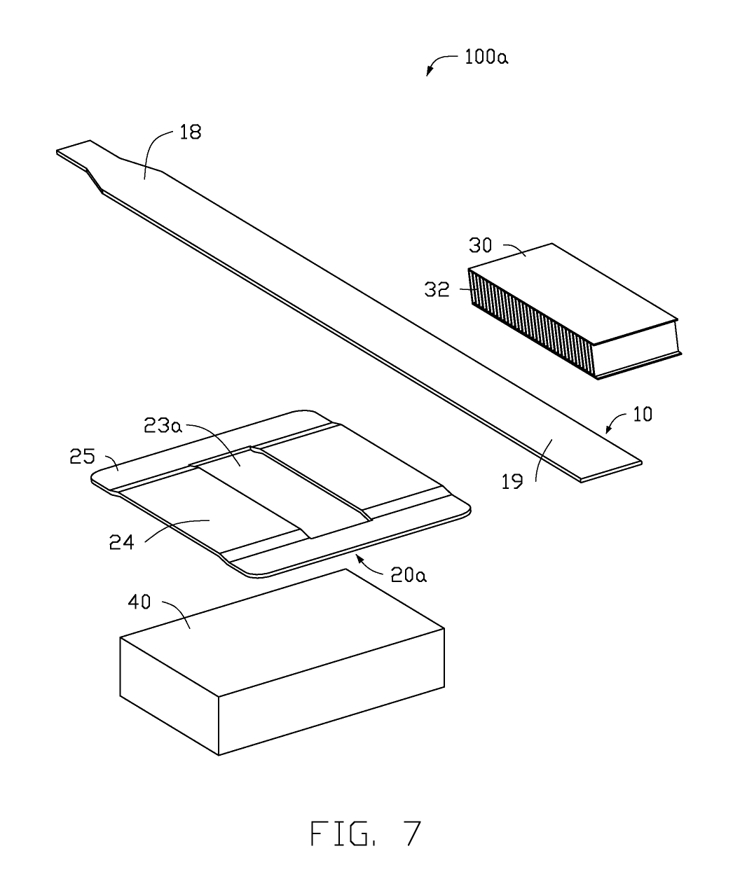

FIGS. 6 and 7 illustrate a heat sink 100a in accordance with a second embodiment of the present disclosure. The heat sink 100a includes a heat pipe 10a, a metal board 20a and a group of fins 30. The heat sink 100a is used for dissipating heat from the electronic component 40. Differences between the second embodiment and the first embodiment are described as following. A length of the heat pipe 10a is larger than a length of the metal board 20a. The metal board 20a can be a folded plate. The metal board 20a includes a first face 24 in a plane and a second face 25 in a different plane on the same side thereof. The first face 24 and the second face 25 are aslant connected. A height difference is between the first face 24 and the second face 25. The height difference can be equal to a thickness of the heat pipe 10a. Alternatively, the height difference can also be less than the thickness of the heat pipe 10a, thereby at least one surface 16 of the heat pipe 10 overtops the first face 24 or the second face 25 of the metal board 20a. An opening 23′ is defined in the metal board 20a and penetrates through the metal board 20a, the first face 24 and the second face 25. The heat pipe 10a includes an evaporator section 18 and a condenser section 19. The evaporator section 18 of the heat pipe 10a is received in the opening 23a of the metal board 20a and carried on the first face 24, and the condenser section 19 of the heat pipe 10a extends out of the metal board 20a and thermal contacts with the group of fins 30.

The group of fins 30 includes a plurality of fins 30 spaced from each other.

Each fin 30 extends along a lengthwise direction of the heat pipe 10a.

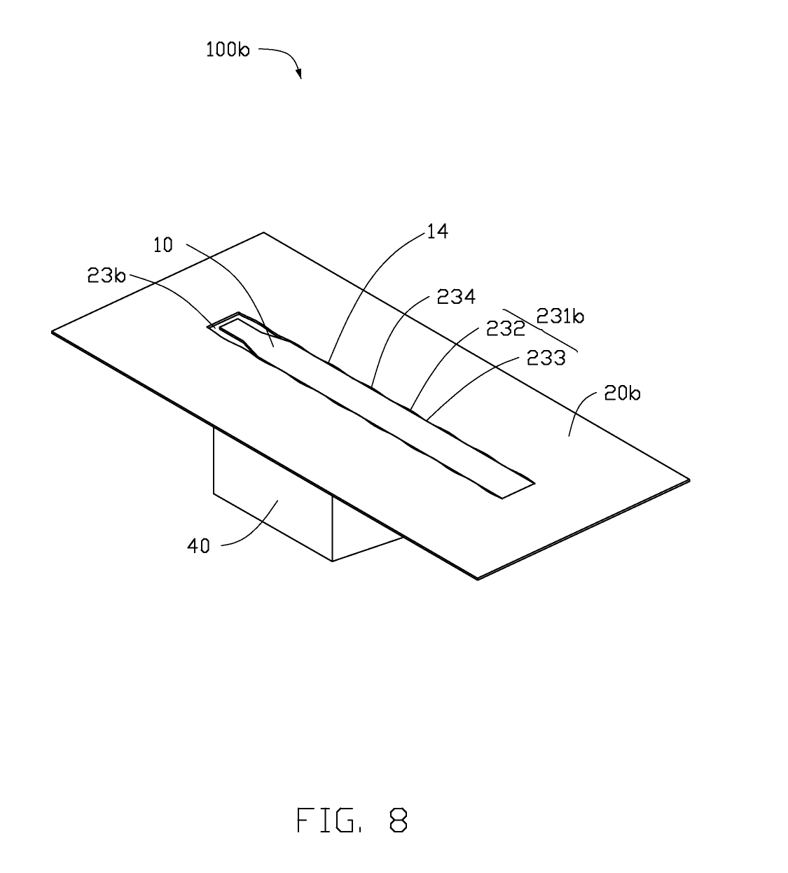

FIG. 8 illustrates a heat sink 100b in accordance with a third embodiment of the present disclosure. The heat sink 100b includes a heat pipe 10 and a metal board 20b. An opening 23b is defined in the metal board 20b. A difference between the third embodiment and the first embodiment is that inner walls 231b of the opening 23b are non-planar. Each inner wall 231b includes a convex portion 232 and a concave portion 233. The convex portions 232 and the concave portions 233 are connected to form a wave-like wall. The heat pipe 10 is received in the opening 23b. The convex portions 232 of the inner wall 231b are interference fit to the heat pipe 10. Gaps 234 are defined in the concave portions 233, between the heat pipe 10 and the metal board 20b.

It is to be further understood that even though numerous characteristics and advantages have been set forth in the foregoing description of embodiments, together with details of the structures and functions of the embodiments, the disclosure is illustrative only; and that changes may be made in detail, according in matters of shape, size, and arrangement of parts within the principles of the disclosure to the full extent indicated by the broad general meaning of the terms in which the appended claims are expressed.

The embodiments shown and described above are only examples. Many details are often found in the art such as the other features of a heat sink. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A heat sink configured for dissipating heat from an electronic component, the heat sink comprising:
a heat pipe; and
a metal board comprising a first face and a second face, an opening being defined in the metal board, the opening penetrating the first face and the second face, the heat pipe being received in the opening, and the opening being an interference fit to the heat pipe.

2. The heat sink of claim 1, wherein the heat pipe comprises two opposite sides on the left and the right thereof, the opening comprises inner walls, and the sides are abutted on the inner walls respectively.

3. The heat sink of claim 2, wherein the inner walls are four planes end to end.

4. The heat sink of claim 2, wherein each inner wall comprises a convex portion and a concave portion, and the convex portions of the inner walls are an interference fit to the heat pipe.

5. The heat sink of claim 2, wherein a solder is welded between the sides of the heat pipe and the corresponding wall of the opening.

6. The heat sink of claim 1, wherein the metal board is a planer plate, the first face of the metal board is on an opposite side of the second face, and a thickness of the metal board is a distance between the first face and the second face.

7. The heat sink of claim 6, wherein a thickness of the heat sink is equal to the thickness of the metal board.

8. The heat sink of claim 6, wherein the heat pipe further comprises two surfaces on the top and bottom thereof, the two surfaces are coplanar to the first face and the second face of the metal board, respectively.

9. The heat sink of claim 1, wherein the metal board is a folded plate, the first face of the metal board is on the same side of the second face, a height difference is between the first face and the second face, and a thickness of the metal board is a distance between the first face and the second face.

10. The heat sink of claim 9, wherein the heat pipe comprises an evaporator section and a condenser section, the evaporator section is received in the opening of the metal board and carried on the first face.

11. The heat sink of claim 10, wherein a length of the opening is less than a length of the heat pipe, the condenser section extends out of the metal board to thermal contact with a group of fins.

12. The heat sink of claim 9, wherein one of the surfaces of the heat pipe is attached on the first face of the metal board.

13. The heat sink of claim 9, wherein one of the surfaces of the heat pipe is coplanar to the second face of the metal board.

14. The heat sink of claim 9, wherein one of the surfaces of the heat pipe overlaps the second face of the metal board.

15. The heat sink of claim 1, wherein a length of the opening is larger than a length of the heat pipe and a width of the opening is equal to a width of the heat pipe.

16. A method for manufacturing a heat sink comprising:
preparing a semi-finished heat pipe and a metal board;
defining an opening in the metal board;
receiving the semi-finished heat pipe in the opening; and
flatting the semi-finished heat pipe to form a heat pipe having a smaller thickness, and the opening being an interference fit to the heat pipe.

17. The method of claim 16, wherein a step of welding solder between the metal board and the heat pipe is performed after the step of flatting the semi-finished heat pipe to the heat pipe having a smaller thickness.

18. The method of claim 16, wherein before the step of flatting the semi-finished heat pipe to the heat pipe having a smaller thickness, a thickness of the semi-finished heat pipe is larger than that of the metal board.

19. The method of claim 16, wherein the metal board is a planar plate.

20. The method of claim 16, wherein the metal board is a folded plate manufactured by extrusion molding or casting molding.
